(19) United States
(12) Patent Application Publication
(10) Pub. No.: US 2005/0232565 A1
(43) Pub. Date: Oct. 20, 2005

(54) Normal through optical panel

(76) Inventors: Ross Heggestad, Apple Valley, MN (US); Joy McKnight, Carver, MN (US); Kristofer Bolster, Jordan, MN (US); Trevor Smith, Eden Prairie, MN (US); Carlos Arroyo, Juarez (MX); Celsa Mora, Juarez (MX)

Correspondence Address: Steven C. Bruess;Merchant & Gould P.C., P.O. Box 2903, Minneapolis, MN, 55402-0903, US

(21) Appl. No.: 10/826,152

(22) Filed: Apr. 16, 2004

(51) Int. Cl. G02B 6/00

(52) U.S. Cl. 385/135

(57) ABSTRACT

A fiber optic connection panel including a plurality of circuits. The circuits are accessed through termination locations. Preferably, IN and OUT termination locations are located on a first side of the panel during normal through operation. A switch included in the circuitry disconnects the IN and OUT circuit paths on the first side, and connects each of the termination locations to further termination locations, located on an opposite side of the panel in a patched state. Preferably, at least one of the circuit paths includes a monitor circuit. A chassis is provided including a plurality of circuit modules mounted to the chassis, wherein the circuit modules contain circuitry with exposed termination locations wherein the circuitry allows normal through and patched circuit paths selectively linking different termination locations.

### FIELD OF THE INVENTION

The present invention relates to fiber optic connection panels.

### BACKGROUND OF THE INVENTION

Fiber optic connection panels are known which connect various pieces of fiber optic equipment. The fiber optic connection panels include ports for connecting to fiber optic cables, to link the equipment. Various functions are useful in the fiber optic connection panels. One function is monitoring of the signal pathways. Another useful function is switching between equipment if a need arises without having to reconnect the equipment cables. Improvements are desired.

### SUMMARY OF THE INVENTION

The present invention provides a fiber optic connection panel with a normal through configuration to link optical equipment. Preferably, the panel has monitor access. The panel can preferably be reconfigured to change the circuit pathways, when desired.

The present invention relates to a fiber optic connection panel including a plurality of circuits. The circuits are accessed through termination locations or ports. Preferably, IN and OUT termination locations are located on a first side of the panel during a normal through state. A switch included in the circuitry disconnects the IN and OUT termination locations, and connects each of the IN and OUT termination locations to further IN and OUT termination locations or ports, located on an opposite side of the panel in a patched state. Preferably, at least one of the circuit paths includes a monitor circuit and a termination location or port.

In one preferred embodiment, a chassis is provided including a plurality of circuit modules mounted to the chassis, wherein the circuit modules contain circuitry with exposed termination locations where the circuitry allows normal through and patched circuit paths selectively linking different termination locations.

### BRIEF DESCRIPTION OF THE DRAWINGS

FIG. 1 is a front elevational view of a fiber optic connection panel in accordance with the present invention.

FIG. 2 is a front elevational view of the connection panel of FIG. 1 with the front cover removed.

FIG. 3 is a rear elevational view of the connection panel of FIG. 1.

FIG. 4 is a rear elevational view of the connection panel of FIG. 1 with the rear cover removed.

FIG. 5 is a right side elevational view of the connection panel of FIG. 1.

FIG. 6 is a front perspective view of the connection panel of FIG. 1 with the front cover in the pivoted open position.

FIG. 7 is a rear perspective view of the connection panel of FIG. 1 with the rear cover in the pivoted open position.

FIG. 8 is an exploded front perspective view of the connection panel of FIG. 1.

FIG. 9 is an exploded rear perspective view of the connection panel of FIG. 1.

FIG. 10 is a further exploded front perspective view of the connection panel of FIG. 1.

FIG. 11 is a front perspective view of a circuit module from the connection panel of FIG. 1.

FIG. 12 is a rear perspective view of the circuit module of FIG. 11.

FIG. 13 is a front elevational view of the circuit module of FIG. 11.

FIG. 14 is a rear elevational view of the circuit module of FIG. 11.

FIG. 15 is a side elevational view of the circuit module of FIG. 11 with one side panel removed.

FIG. 16 is a circuit schematic for a portion of the circuitry within the circuit module of FIG. 11.

FIG. 17 is a schematic showing the normal through signal pathway through one of the circuits in the circuit module of FIG. 11.

FIG. 18 is a schematic showing the patched signal pathway through one of the circuits in the circuit module of FIG. 11.

FIG. 19 is another schematic showing the normal through signal pathways through the circuit module.

FIG. 20 is a schematic like FIG. 19 showing the patched signal pathways through the circuit module.

FIG. 21 is an exploded perspective view of an alternative embodiment of a connection panel including splices.

### DETAILED DESCRIPTION OF THE PREFERRED EMBODIMENT

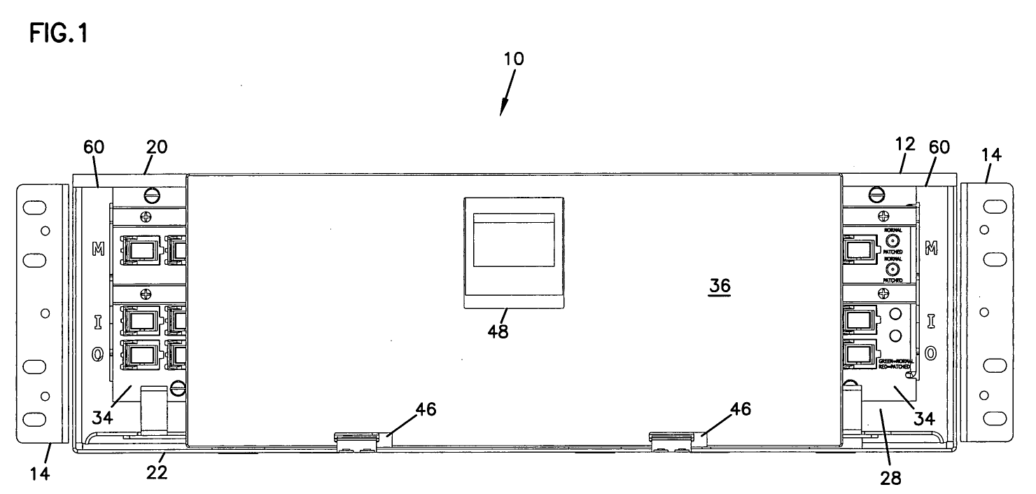

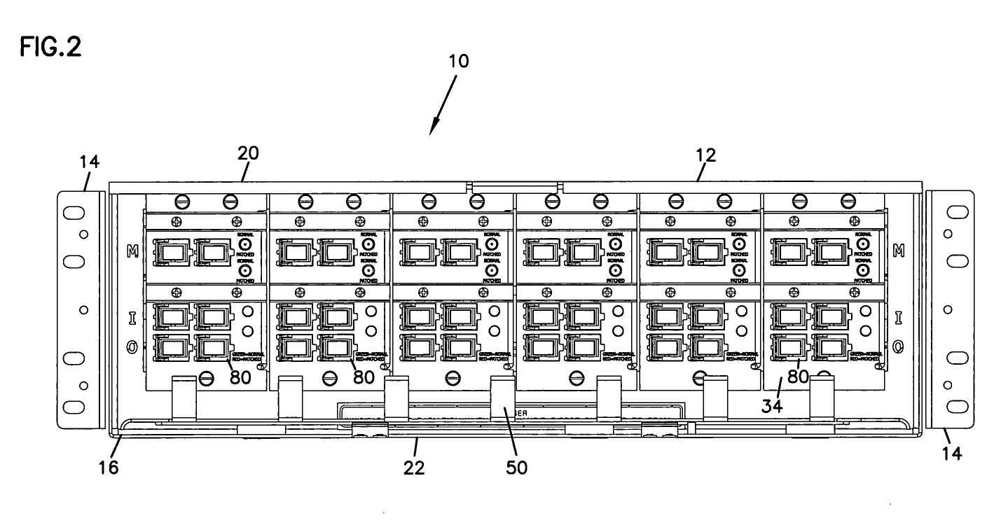

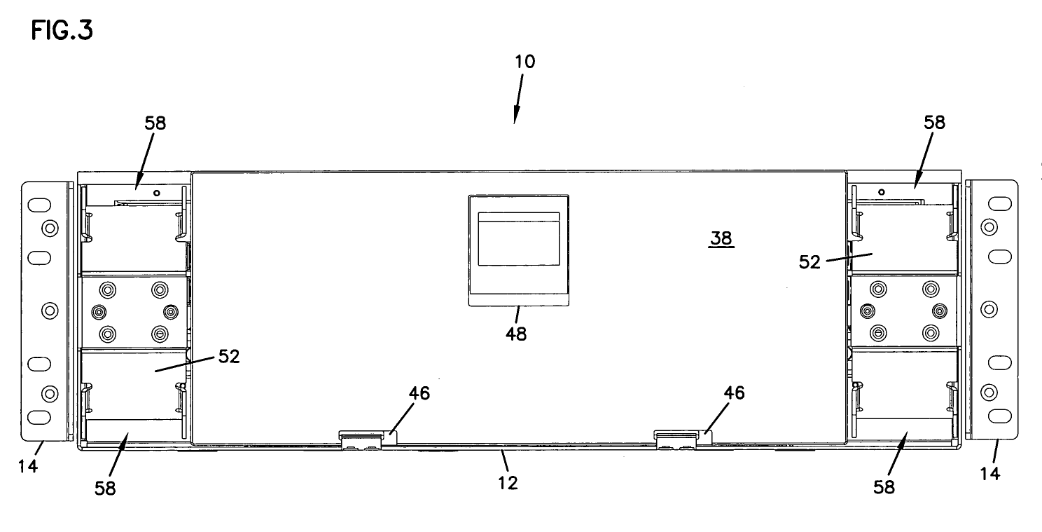

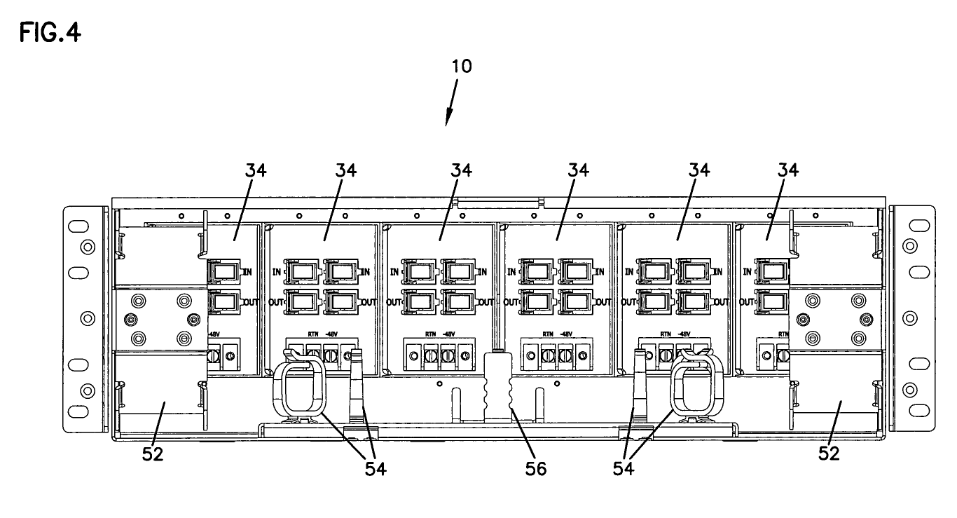

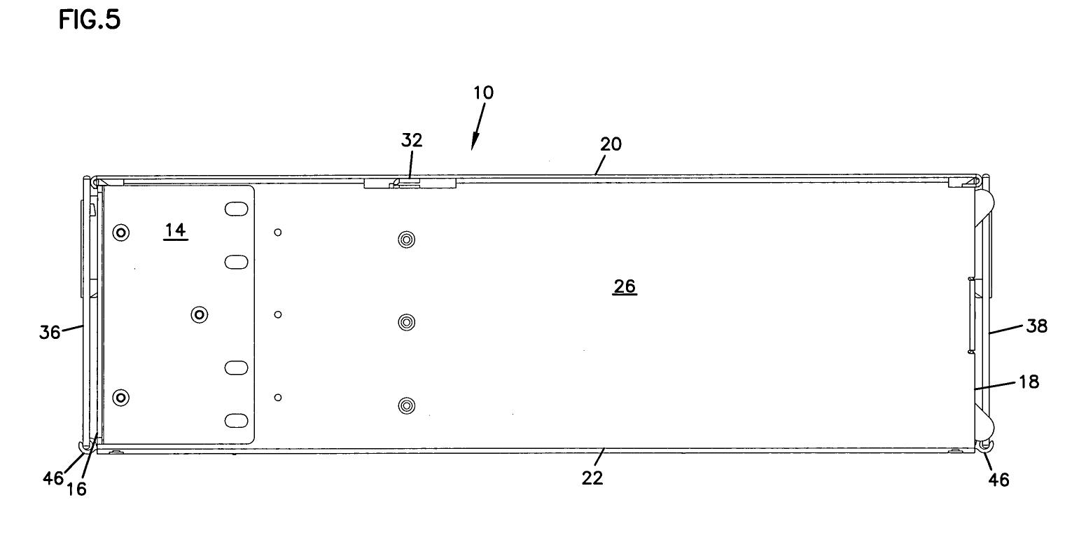

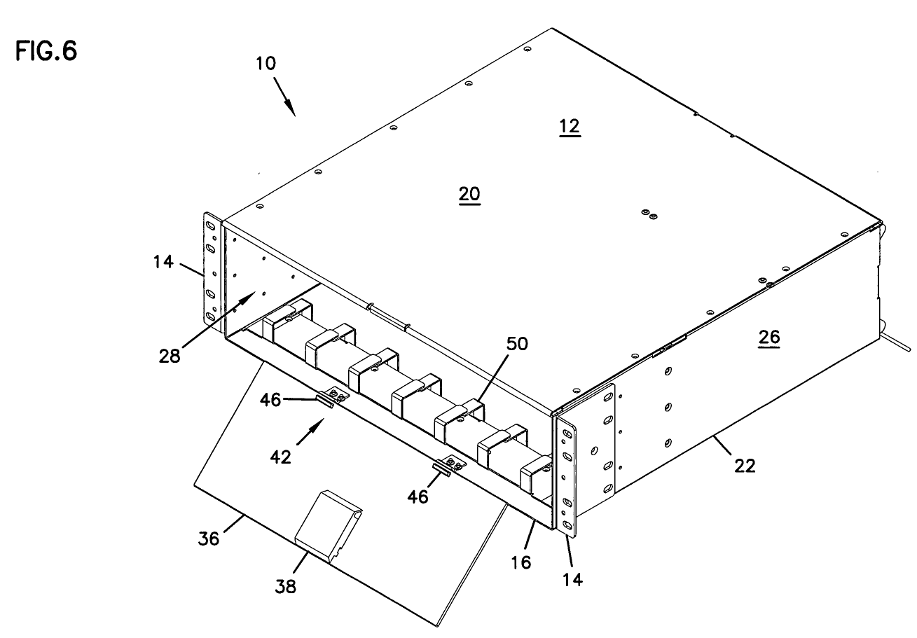

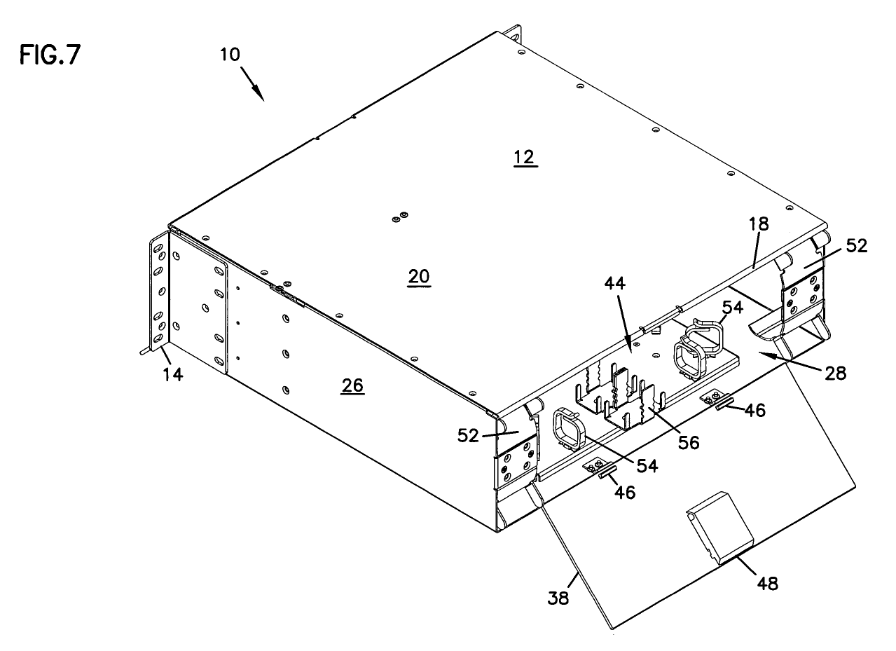

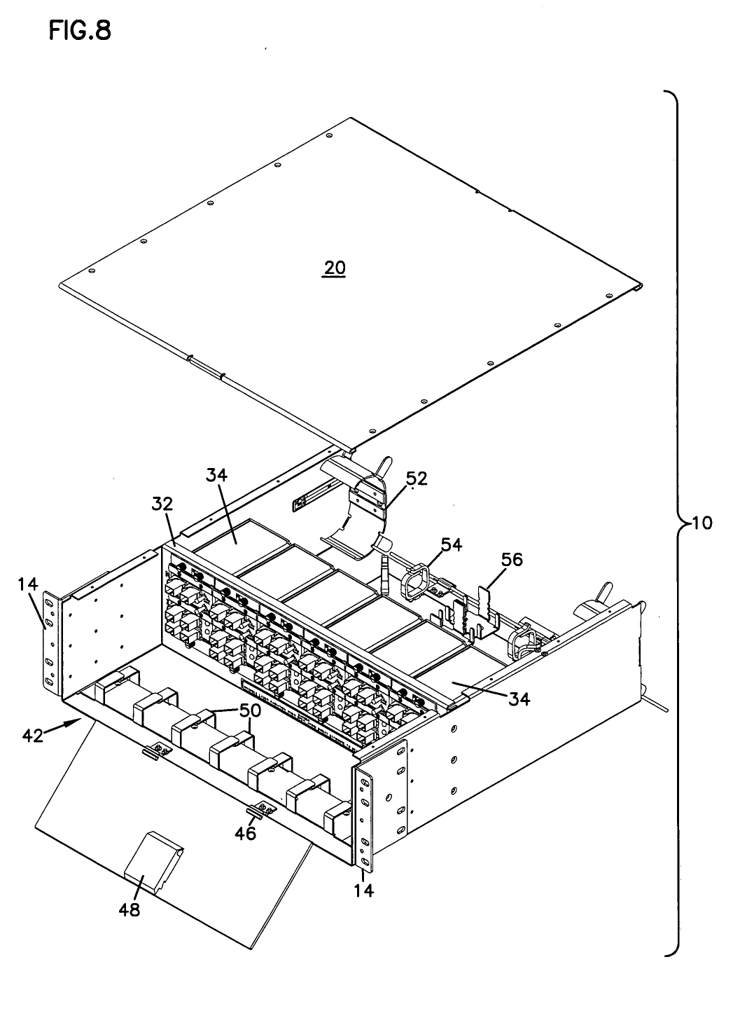

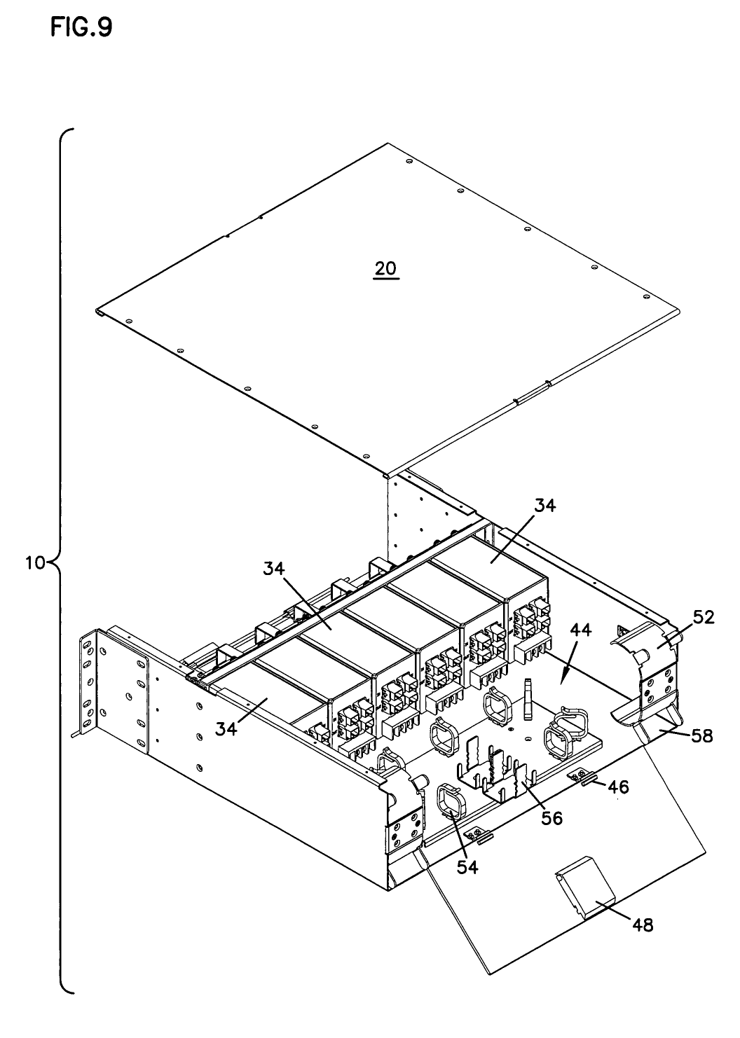

Referring now to FIGS. 1-10, a fiber optic communications panel 10 is shown. Panel 10 includes a chassis 12 with brackets 14 for mounting panel 10 to a rack, frame, cabinet, or other structure. Panel 10 includes circuitry which connects fiber optic cables and equipment. The circuitry includes a normal through state, and also a patched state for use in changing the connections between the equipment. The preferred circuitry also includes monitor functions for monitoring signals through panel 10.

Panel 10 includes a front 16, and an opposite rear 18. A top 20, an opposite bottom 22, a left side 24, and a right side 26 cooperate with front and back 16, 18 to define an interior 28 for holding the circuitry. Disposed within interior 28 is a bulkhead 32 which holds a plurality of circuit modules 34 containing the circuitry.

Panel 10 includes a pivoting front cover 36, and a pivoting rear cover 38 for allowing selective access to interior 28 through front 16 or back 18, respectively. Front and rear covers 36, 38 include hinges 46, and latches 48 for selectively latching covers 36, 38 in the closed positions.

Panel 10 includes a front cable management arrangement 42 disposed between bulkhead 32 and front 16. Behind bulkhead 32, and modules 34, panel 10 includes a rear cable management arrangement 44. Both front and rear cable management arrangements 42, 44 are configured for managing cables extending to and from modules 34. Front cable management arrangement 42 includes a plurality of front cable rings 50. Cables extending to the fronts of modules 34 are managed by rings 50 and exit chassis 12 at openings 60 defined by the ends of front cover 36.

Rear cable management arrangement 44 includes a plurality of rear cable rings 54. Cable rings 54 are used for slack storage of cables extending into chassis 12 toward modules 34.

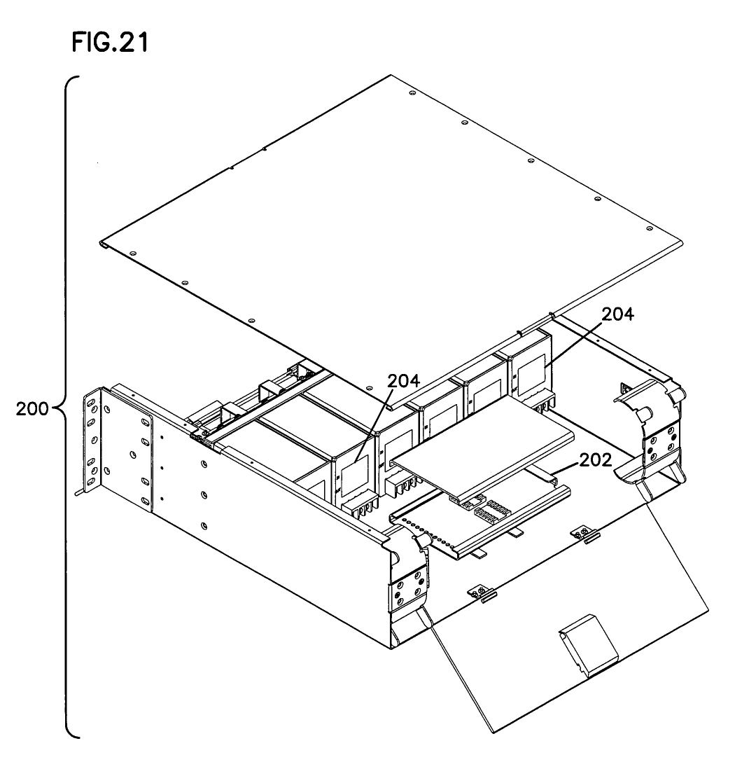

Rear vertical radius limiters 52 define rear openings 58 for cables entering and exiting panel 10. Fan out mounts 56 are also provided in rear cable management arrangement 44 for use in fanning out ribbon cables. Alternatively, rear cable management arrangement 44 includes splice trays for holding cable splices. FIG. 21 shows an alternative panel 200 including a splice tray 202.

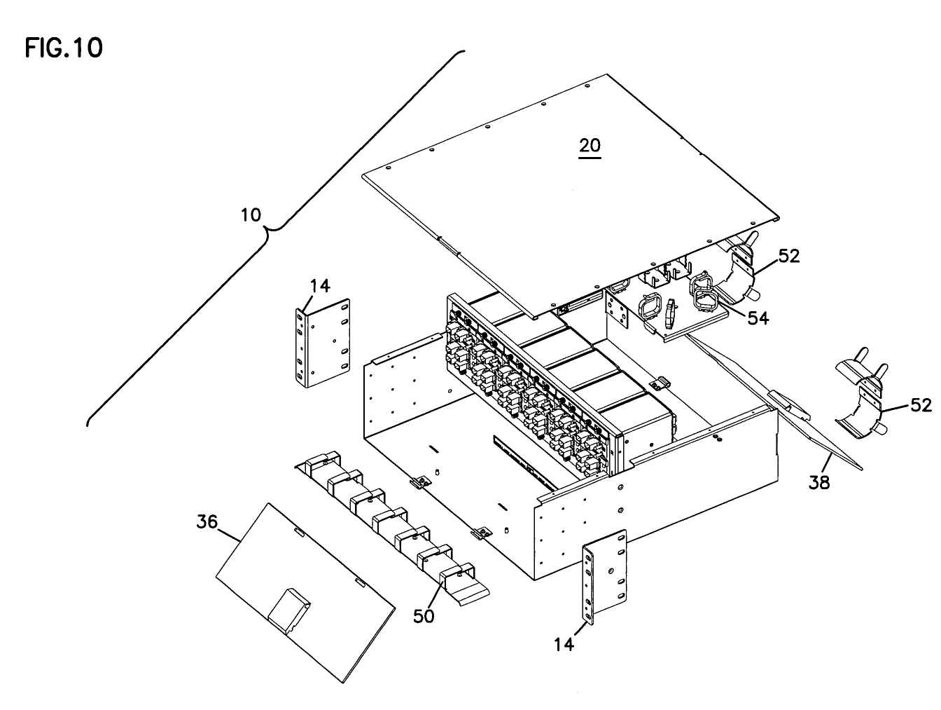

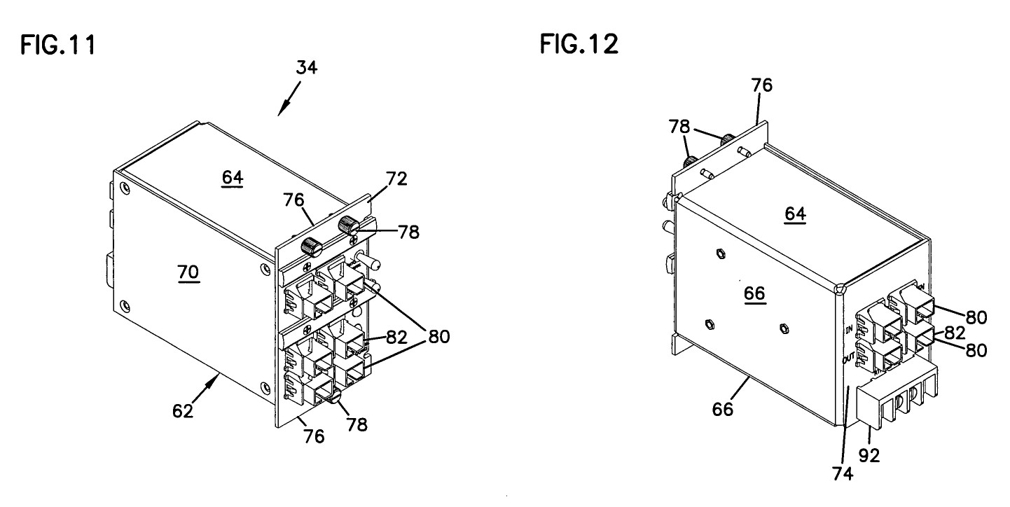

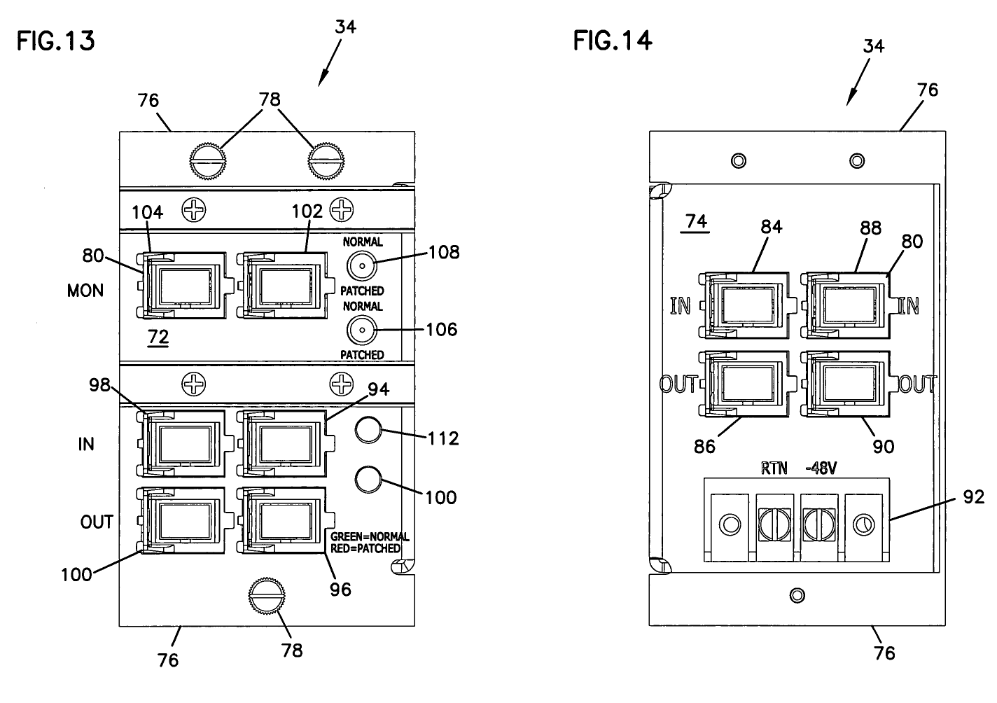

Referring now to FIGS. 10-15, one of modules 34 is shown including a module housing 62 including a first side 64, a second side 66, a third side 68, and a fourth side 70. A front face 72, and an opposite rear face 74 cooperate with sides 64, 66, 68, 70 to define an interior 75 for holding circuit elements. Front face 72 includes opposed flanges 76 for mounting to bulkhead 32 with fasteners 78.

Rear face 74 of module 34 includes a plurality of termination locations or ports 80 for accessing the fiber optic circuitry contained within module housing 62. Preferably each termination location 80 includes a fiber optic adapter 82. The illustrated adapters 82 are SC type adapters. Each termination location in panel 10 defines a port for connecting to a fiber optic cable. A first port 84 defines a first IN port or input port. A second port 86 defines an OUT port or output port. Rear face 74 further includes a second IN port 88 and a second OUT port 90. Rear face 74 also includes a power connector 92. In normal operation, in the normal through state, port 84 is connected to port 86 and port 88 is connected to port 90.

Front face 72 of module housing 62 includes a first IN port 94, and a first OUT port 96. Front face 72 further includes a second IN port 98, and a second OUT port 100. In the normal through operation, front ports 94, 96, 98, 100 are not connected to rear ports 84, 86, 88, 90. In the patched operation, front port 94 is connected to rear port 86. Further, front port 96 is connected to rear port 84, front port 98 is connected to rear port 90, and front port 100 is connected to rear port 88. Front face 72 further includes two monitor ports 102, 104 for connecting to rear ports 86, 90, respectively.

Switches 106, 108 on front face 72 control switching between the normal through and the patched configurations. First and second visual indicators 110, 112 indicate which state the switch is in. Switches 106, 108 are manually operated toggle switches. Other manually operated switches could be used, such as push buttons. Visual indicators 110, 112 are electrically powered LED's in the illustrated embodiment. The indicators are optional, since the position of the toggle switches 106, 108 can also indicate the state of the switching circuit.

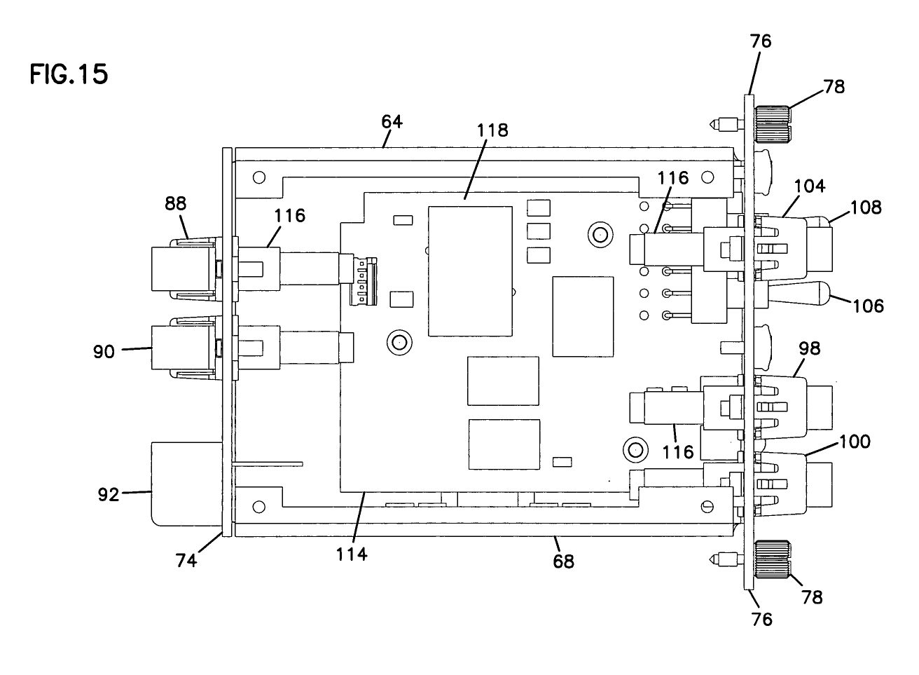

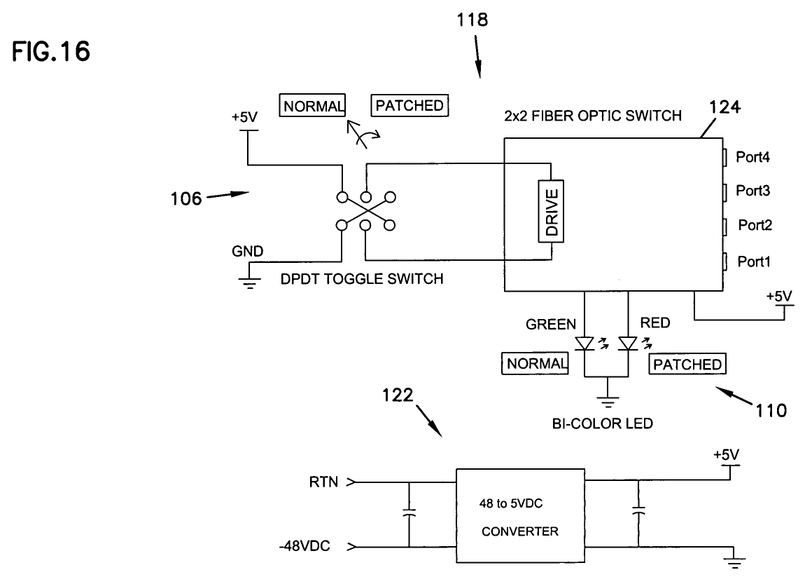

Referring now to FIG. 15, interior 75 of module 34 includes a printed circuit board 114 including fiber to PC connectors 116 and circuitry 118. The fiber to PC connectors 116 link ports 82, 84, 86, 88, 90, 94, 96, 98, 100 to PCB 114. Circuitry 118 controls operation of the circuit conditions between the normal through state and the patched state. Circuitry 118 (see FIG. 16) includes a power conversion circuit 122 for converting minus 48 VDC to plus 5 volts for operating a 2×2 optical switch 124. Each toggle switch 106, 108 switches the respective optical switch 124 between states. LED's 110, 112 indicate to the operator the state of the 2×2 switch 124. The monitor function is carried out by a splitter 126, such as a 90/10 splitter.

With circuitry 118, each module 34 can provide a transmit signal pathway and a receive signal pathway. Two modules 34 can be cross-connected together to cross-connect two pieces of equipment.

Module 34 includes two circuits, each with two input ports and two output ports in the normal through state and in the patched state. Module 34 can also be packaged each with a single circuit, if desired. By packaging two circuits in one module, a single 2×2 optical switch can be used to control the circuit states. In single circuit modules, a 1×2 switch would be needed for each module. With the dual circuit module, less switches are needed for the overall system.

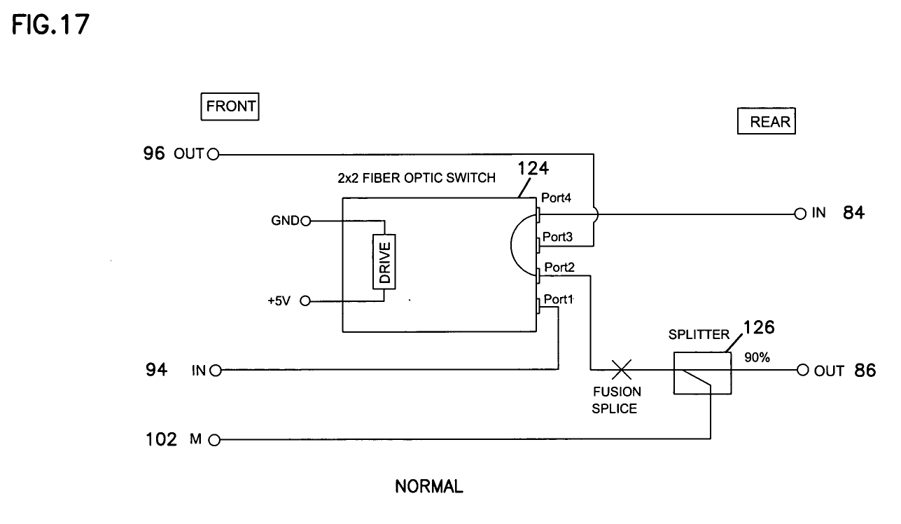

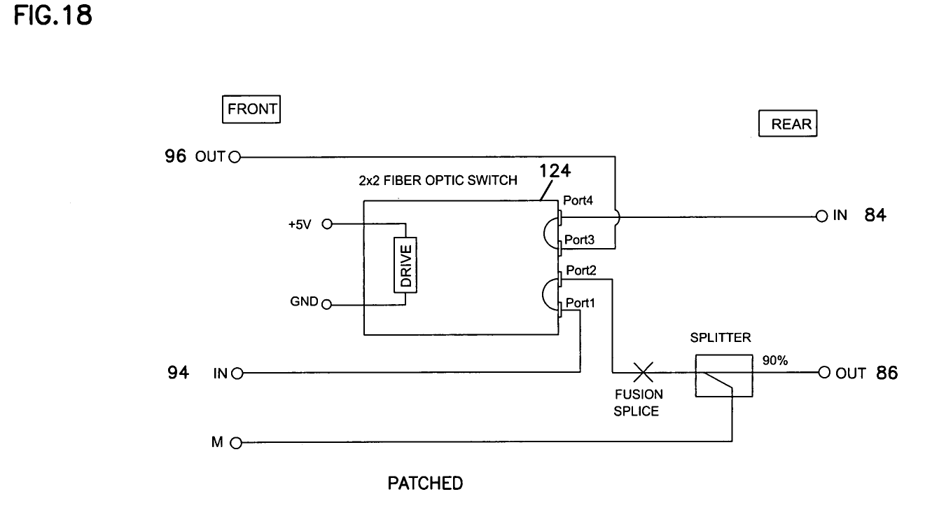

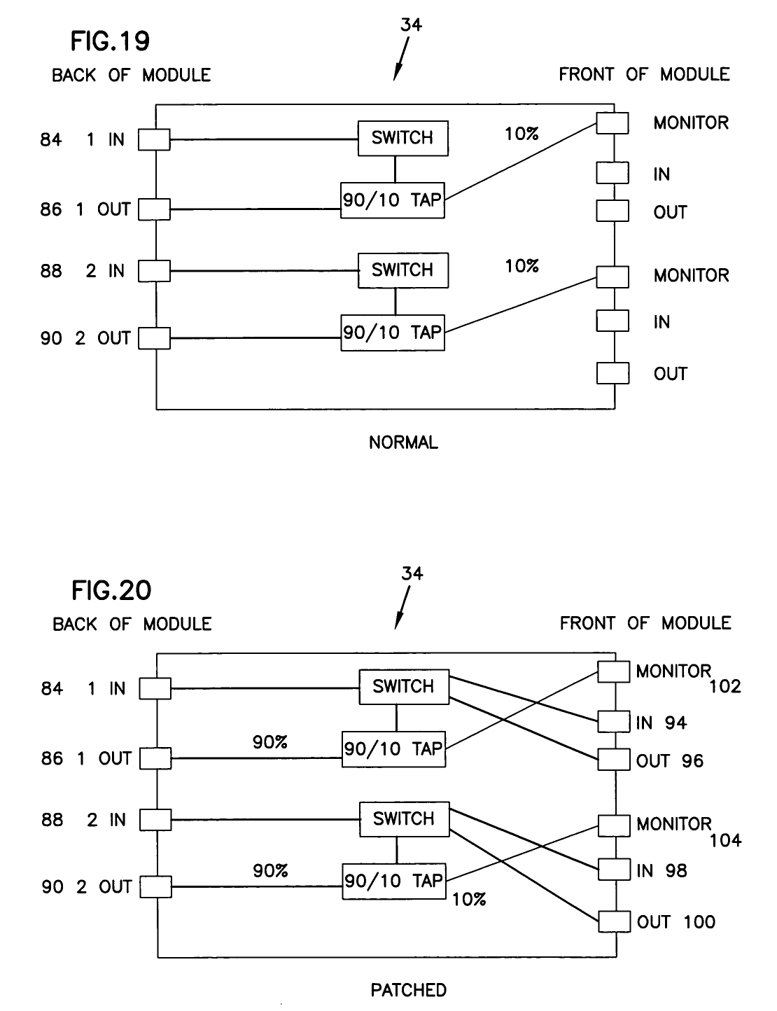

While the illustrated embodiment of FIGS. 1-20 uses adapters 82 on rear face 74 of module 34, module 34 can be provided with pigtails which extend out from the interior of the module through an opening 204 in the module and connect to fiber optic cables, such as through a splice in a splice tray of the panel 200 (see FIG. 21). Splice trays 202 can be used in rear cable management arrangement 44, instead of the noted cable clips and fan out mounts as shown in FIG. 21.

The above specification, examples and data provide a complete description of the manufacture and use of the composition of the invention. Since many embodiments of the invention can be made without departing from the spirit and scope of the invention, the invention resides in the claims hereinafter appended.

1. A fiber optic connection panel comprising:
(a) a chassis;
(b) a plurality of circuit modules mounted to the chassis wherein:
two input ports are positioned on a rear face of each circuit module;
two output ports are positioned on the rear face of the circuit module;
two input ports are positioned on a front face of the circuit module opposite the rear face;
two output ports are positioned on the front face of the circuit module;
two monitor ports are positioned on the front face of the circuit module;
two switches are positioned on the front face of the circuit module;
two visual indicators are positioned on the front face of the circuit module;
a power input connector is positioned on the rear face of the circuit module;
each circuit module including circuitry selectively linking the input and output ports on the rear face to each other, and to the input and output ports on the front face, respectively, wherein the circuitry defines two normal through paths each linking one of the input ports on the rear face to one of the output ports on the rear face, wherein the circuitry defines patched paths each linking one of the input ports on the rear face to one of the output ports on the front face, and one of the output ports on the rear face to one of the input ports on the front face, and further wherein the switches on the front face operate the circuitry to switch between normal through paths and patched paths, and further wherein the visual indicators indicate which state the circuitry is in.

2. The fiber optic connection panel of claim 1, further comprising a first cable management arrangement for managing cables connected to the input and output ports of the rear face.

3. The fiber optic connection panel of claim 2, further comprising a second cable management arrangement for managing cables connected to the input and output ports of the front face.

4. The fiber optic connection panel of claim 1, wherein the visual indicators include LED's.

5. The fiber optic connection panel of claim 1, wherein the switches include toggle switches.

6. The fiber optic connection panel of claim 1, wherein the ports include fiber optic adapters.

7. The fiber optic connection panel of claim 1, wherein the ports include an opening for fiber optic pigtails.

8. The fiber optic connection panel of claim 1, wherein the circuitry includes a 2×2 optical switch.

9. A fiber optic connection panel comprising:
(a) a chassis;
(b) a plurality of circuit modules mounted to the chassis wherein:
an input port is positioned on a rear face of each circuit module;
an output port is positioned on the rear face of the circuit module;
an input port is positioned on a front face of the circuit module opposite the rear face;
an output port is positioned on the front face of the circuit module;
a monitor port is positioned on the circuit module;
a switch is positioned on the circuit module;
a power input connector is positioned on the circuit module;
each circuit module including circuitry selectively linking the input and output ports on the rear face to each other, and to the input and output ports on the front face, respectively, wherein the circuitry defines a normal through path linking the input port on the rear face to the output port on the rear face, wherein the circuitry defines patched paths each linking the input and output ports on the rear face to the output and input ports, respectively, on the front face, and further wherein the switch on the front face operates the circuitry to switch between a normal through path and patched paths.

10. The fiber optic connection panel of claim 9, further comprising a first cable management arrangement for managing cables connected to the input and output ports of the rear face.

11. The fiber optic connection panel of claim 10, further comprising a second cable management arrangement for managing cables connected to the input and output ports of the front face.

12. The fiber optic connection panel of claim 9, further comprising a visual indicators including an LED to indicate the status of the circuitry.

13. The fiber optic connection panel of claim 9, wherein the switch includes a toggle switch.

14. The fiber optic connection panel of claim 9, wherein the ports include fiber optic adapters.

15. The fiber optic connection panel of claim 9, wherein the ports include an opening for fiber optic pigtails.

16. The fiber optic connection panel of claim 9, wherein the circuitry includes an optical switch.

17. A fiber optic module comprising:
(a) a module housing having front and rear faces;
(b) two input ports positioned on the rear face;
(c) two output ports positioned on the rear face;
(d) two input ports positioned on the front face;
(e) two output ports positioned on the front face;
(f) two monitor ports positioned on the front face;
(g) two switches positioned on the front face;
(h) a power input connector positioned on the rear face of the circuit module;
(i) circuitry within the module housing selectively linking the input and output ports on the rear face to each other, and to the input and output ports on the front face, respectively, wherein the circuitry defines two normal through paths each linking one of the input ports on the rear face to one of the output ports on the rear face, wherein the circuitry defines patched paths each linking one of the input ports on the rear face to one of the output ports on the front face, and one of the output ports on the rear face to one of the input ports on the front face, and further wherein the switches on the front face operate the circuitry to switch between normal through paths and patched paths.

18. The fiber optic module of claim 17, further comprising two visual indicators positioned on the front face of the module housing, and further wherein the visual indicators indicate which state the circuitry is in.

19. The fiber optic module of claim 17, further comprising a flange extending from the module housing for receipt of a fastener for mounting the module housing to a chassis.
